(19) United States
(12) Patent Application Publication
(10) Pub. No.: US 2025/0125874 A1
(43) Pub. Date: Apr. 17, 2025

(54) DUAL-HOP SYSTEM FOR OPTICAL WIRELESS COMMUNICATION

(71) Applicant: KING FAHD UNIVERSITY OF PETROLEUM AND MINERALS, Dhahran (SA)

(72) Inventors: Khurram Karim QURESHI, Dhahran (SA); Jawad MIRZA, Islamabad (PK); Ahmad ATIEH, Ottawa (CA); Salman Abdul GHAFOOR, Islamabad (PK); Sheikh Sharif IQBAL, Dhahran (SA)

(73) Assignee: KING FAHD UNIVERSITY OF PETROLEUM AND MINERALS, Dhahran (SA)

(21) Appl. No.: 18/490,381

(22) Filed: Oct. 19, 2023

Related U.S. Application Data
(60) Provisional application No. 63/589,350, filed on Oct. 11, 2023.

(51) Int. Cl. H04B 10/118; H01S 3/067; H01S 3/094; H04B 10/564

(52) U.S. Cl. CPC H04B 10/118; H04B 10/564; H01S 3/06716; H01S 3/094003

(57) ABSTRACT

A dual-hop system for optical wireless communication between a base station on Earth and satellite is described. The system includes a first Thulium-Doped Fiber Amplifier (TDFA) at the base station and a second TDFS installed in a High-Altitude Platform Station (HAPS). The first TDF A includes a first thulium-doped fiber (TDF) and a first set of optical pumps. The first TDFA amplifies an input optical signal for wireless transmission to the HAPS installed at a specific altitude. The amplified signal is received by the second TDFA at HAPS. The second TDFA includes a second TDF and a second set of optical pumps. The signal amplified by the second TDFA is compensated for attenuation before it is wirelessly transmitted to the satellite. Both TDFAs ensure that the amplification of the optical signals, either through power amplification or gain, meets specified criteria to maintain the integrity and quality of the transmitted signals.

### CROSS-REFERENCE TO RELATED APPLICATIONS

The present application claims priority to U.S. Provisional Application No. 63/589,350, filed Oct. 11, 2023, the entire contents of which is incorporated by reference herein in its entirety for all purposes.

### STATEMENT REGARDING PRIOR DISCLOSURE BY THE INVENTORS

Aspects of this technology are described in an article “Design of an efficient thulium-doped fiber amplifier for dual-hop earth to satellite optical wireless links”, published in Ain Shams Engineering Journal, on Oct. 13, 2022, which is incorporated herein by reference in its entirety.

### BACKGROUND

### Technical Field

The present disclosure is directed to employing a thulium-doped fiber amplifier (TDFA) as a booster in a dual-hop system for optical wireless communication (OWC).

### Description of Related Art

The “background” description provided herein is for the purpose of generally presenting the context of the disclosure. Work of the presently named inventors, to the extent it is described in this background section, as well as aspects of the description which, may not otherwise qualify as prior art at the time of filing, are neither expressly or impliedly admitted as prior art against the present disclosure.

In modern digital age, rapidly evolving technological landscape demand for efficient and robust communication networks facilited by the global communication infrastructure. Currently, the global communication infrastructure is based on various technologies, such as silica-based single-mode fibers (SMFs), Erbium-doped fiber amplifiers (EDFAs), wavelength division multiplexing (WDM), and digital coherent transmission. These technologies have exhibited a transmission speed and capacity, for instance, 1.6 Tb/s by WDM of 160 optical channels over a single SMF. Concurrently, an influx of technological applications, such as Internet of Things (IoT), high-definition televisions (HDTVs), online streaming, video gaming, video conferencing, and social media platforms has exponentially amplified internet traffic. Evidently, such surge is propelling telecommunication networks swiftly towards the capacity limits, also known as ‘capacity crunch’, where the demand for high-speed, high-data rate transmission is rapidly approaching the network's capacity.

Traditionally, fibre-optic transmission systems have relied on the 1550 nm optical window. However, the rapid expansion in data traffic necessitates the exploration and incorporation of new optical windows and innovative solutions. The current solutions include the utilization of advanced multi-level modulation formats (e.g., PAM-4/8, 64-QAM), the development of communication systems based on multi-mode fibers (MMFs), and the establishment of efficient multi-band transmission (MBT) systems are being considered to optimize the utilization of the available limited resources.

To overcome the contraints of the 1550 nm optical window, the 1900 nm optical window is gaining traction in the field of optical communication. Thulium-doped fiber amplifiers (TDFAs), operating in the 1750-1950 nm wavelength range, are the amplifiers configured for enhancing the amplification bandwidth. TDFAs have been utilized in various applications including optical communication, spectroscopy, remote sensing, photo-medicine, material processing, and mid-infrared generation.

In another aspect of telecommunication networks, territorial communication is a field where traditional communication networks are often inadequate. Optical Wireless Communication (OWC) technology caters to applications involving satellite communications. The capability of OWC to facilitate data transfer through light, either visible or infrared, has proven beneficial in addressing the limitations of traditional frequency bands and in accommodating the escalating data transmission volumes.

However, OWC is prone to challenges related to performance and reliability being often hampered by atmospheric attenuation, turbulence, and pointing errors. Such factors compromise the link budget and, subsequently, the quality and range of OWC transmissions. The high-power optical signals and booster amplifiers can be implemented to overcome the challenges. Additionally, relay-assisted OWC techniques, such as all-optical amplify and forward (OAF) and all-optical regenerate and forward (ORF) relays, can be implemented to mitigate the limitations imposed by atmospheric and technical constraints.

An amplifier having gain of 30 dB and a noise figure of 8 dB in the 150 nm to 1700 nm range was described (See: Tench R E, Amavigan A, Chen K, Delavaux J-M, Robin T, Cadier B, Laurent A, “Experimental performance of a broadband dual-stage 1950 nm PM single-clad Tm-doped fiber amplifier”, IEEE Photon Technol Lett 2020; 32 (15): 956-9, incorporated herein by reference in its entirety). Further, a tactical deep fiber amplifier (TDFA) that operates at a wavelength of 1952 nm and exhibits low Brillouin losses has been described (See: C. Romano, R. E. Tench, and J-M. Delavaux, “5 W 1952 nm Brillouin-free efficient single clad TDFA”, Optical Fiber Technology, vol. 46, pp. 186-191, 201, incorporated herein by reference in its entirety).

An Ultrafast thulium-doped fiber amplifier having an average output power of 1 kW at a repetition rate of 100 GHz has been described (See: C. Gaida, M. Gebhardt, T. Heuermann, Z. Wang, F. Stutzki, C. Jauregui, and J. Limpert, “Ultrafast Tm-doped fiber amplifier with 1 kW average output power”, in the European Conference on Lasers and Electro-Optics, Optical Society of America, p. cj_10_4, 2019, incorporated herein by reference in its entirety). Also, a mathematical model to analyze the gain and loss mechanisms of the Thulium-doped fiber amplifier has been described (See: Mukhtar S, Aliyu K N, Magam M G, Qureshi K K, “Theoretical analysis of Thulium doped fiber amplifier based on in-band pumping scheme”, Microwave and Optical Technology Letters 2021; 63 (4): 1309-13, incorporated herein by reference in its entirety). A high-efficiency fiber amplifier based on resonant pumping has been described (See: Jin X, Lee E, Luo J, Sun B, Yu X, “High-efficiency ultrafast Tm-doped fiber amplifier based on resonant pumping”, Opt Lett 2018; 43 (7): 1431-4, incorporated herein by reference in its entirety). Further, performance of a thulium-doped fiber amplifier is studied for optical telecom at 2 μm with a pump wavelength of 1570 nm (See: Khamis M A, Ennser K, “Study of heavily Thulium-doped fiber amplifier for optical telecom at 2000 nm”, in IOP Conference Series. Mater Sci Eng 2019; 518 (5): 052017, incorporated herein by reference in its entirety). Also, use of thulium-doped silica fibers for short-wavelength (SH) fiber amplifiers has been described (See: Li Z, Jung Y, Daniel J M O, Simakov N, Tokurakawa M, Shardlow P C, Jain D, “Exploiting the short wavelength gain of silica-based Thulium-doped fiber amplifiers”, Opt Lett 2016; 41 (10): 2197-200, incorporated herein by reference in its entirety).

A thulium-doped fiber amplifier, pumped at 1570 nm and 793 nm in the presence of cross relaxation, has been described (See: M. A. Khamis, and K. Ennser, “Theoretical model of a Thulium-doped fiber amplifier pumped at 1570 nm and 793 nm in the presence of cross relaxation”, Journal of Lightwave Technology, vol. 34, no. 24, pp. 5675-5681, 016, incorporated herein by reference in its entirety). A silica-based Thulium-doped fiber amplifiers for generating high-power, narrow linewidth signals at 1.57 μm and 2.1 μm has been described (See: Y. Jung, Z. Li, N. Simakov, J. M. O. Daniel, D. Jain, P. C. Shardlow, and A. M. Heidt, “Silica-based Thulium doped fiber amplifiers for wavelengths beyond the L band”, in Optical Fiber Communication Conference, Optical Society of America, pp. M3D-5, 2016, incorporated herein by reference in its entirety). Further, a multistage optical fiber amplifier (TDFA) using a shared L-band pump source has been described (See: Tench R E, Romano C, Delavaux J-M, “Multistage single clad 2 μm TDFA with a shared L-band pump source”, Appl Opt 2018; 57 (21): 5948-55., incorporated herein by reference in its entirety).

A performance of a Thulium-doped silica fiber amplifier operating in the S-band frequency range has been studied (See: Singh R, Singh M L, “Performance evaluation of S-band Thulium doped silica fiber amplifier employing multiple pumping schemes”, Optik 2017; 140:565-70, incorporated herein by reference in its entirety). A tandem thulium-doped single clad fiber amplifier that employs a tandem configuration with two stages of doping and amplification has been described (See: Tench R E, Romano C, Delavaux J-M, “Broadband 2 W Output Power Tandem Thulium-Doped Single Clad Fiber Amplifier at 2 μm”, IEEE Photon Technol Lett 2018; 30 (5): 503-6., incorporated herein by reference in its entirety). Further, a 3.5 W broadband hybrid amplifier operating at a wavelength of 2051 nm using Holmium- and Thulium-doped single-clad fibers has been described (See: Tench R E, Amavigan A, Romano C, Traore D, Delavaux J-M, Robin T, Cadier B, Laurent A, Crochet P, “3.5 W broadband PM hybrid amplifier at 2051 nm with Holmium-and Thulium-doped single-clad fibers”, J Lightwave Technol 2021; 39 (5): 1471-6, incorporated herein by reference in its entirety). A broadband linear polarization-maintaining hybrid fiber amplifier has been described (See: Tench R E, Romano C, Delavaux J-M, “25 W 2 μm broadband polarization maintaining hybrid Ho— and Tm— doped fiber amplifier”, Appl Opt 2019; 58 (15): 4170-5, incorporated herein by reference in its entirety). However, the amplifiers described in these references and other conventional systems suffer from various limitations including capacity and efficiency, cost-effectiveness and ability of the solutions to integrate with existing infrastructures.

Therefore, there is a need for a system operating in greater bandwidth, for instance, 1700-1950 nm wavelength range, and which is optimized to achieve high output power and gain for the use in dual-hop Earth to satellite OWC links as booster as well as in-line amplifier, respectively.

### SUMMARY

An embodiment describes a method of transmitting data between Earth and satellite over an optical wireless communication (OWC) channel using a dual-hop system. The method includes amplifying an input optical signal using a first thulium-doped fiber amplifier (TDFA) to generate an amplified signal. The method includes transmitting, from a base station located on the surface of the Earth, the amplified signal to a high-altitude platform station (HAPS) over the OWC channel for further transmission to a satellite in a specified earth orbit, wherein the HAPS is installed at a specified altitude from the surface of the Earth. The method includes compensating, using a second TDFA, for attenuation of the amplified signal by amplifying the amplified signal to generate an output optical signal. The method includes transmitting, from the HAPS, the output optical signal to the satellite over the OWC channel, wherein amplifying using the first TDFA and the second TDFA includes configuring the first TDFA or the second TDFA based on a mode of operation of the first TDFA and the second TDFA to provide an output power or a gain that satisfies a specified criterion.

In another exemplary embodiment, a system for amplifying optical signals is described. The system includes a first thulium-doped fiber amplifier (TDFA), and a second TDFA. The first TDFA is installed in a base station located on the surface of Earth. The first TDFA includes a first thulium-doped fiber (TDF) and a first set of optical pumps. The first TDFA is configured to amplify an input optical signal to generate an amplified signal. The base station is configured to wirelessly transmit the amplified signal to a high-altitude platform station (HAPS) installed at a specified altitude from the surface of Earth. The second TDFA is installed in the HAPS. The second TDFA includes a second TDF and a second set of optical pumps. The second TDFA is configured to compensate for attenuation of the amplified signal by amplifying the amplified signal to generate an output optical signal. The HAPS is configured to further transmit the output optical signal to a satellite wirelessly. The first TDF, the second TDF, the first set of optical pumps and the second set of optical pumps are further configured based on a mode of operation of the first TDFA and the second TDFA to provide a power amplification, or gain in amplifying the input optical signal, that satisfies a specified criterion.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 represents a network diagram of a dual-hop system for optical wireless communication (OWC) between a base station on Earth and satellite, according to aspects of the present disclosure;

FIG. 2A represents an absorption spectrum and an emission spectrum of Tm³⁺.

FIG. 2B represents an energy level diagram of Tm³⁺;

FIG. 3A represents a forward pumping configuration to excite a gain medium of a thulium-doped fiber amplifier (TDFA), according to aspects of the present disclosure;

FIG. 3B represents a bidirectional pumping configuration of the TDFA, according to aspects of the present disclosure;

FIG. 3C represents a dual-stage pumping configuration of the TDFA, according to aspects of the present disclosure;

FIG. 4 is a graph illustrating power versus output power for different pumping configurations, according to aspects of the present disclosure;

FIG. 5 is a schematic representation of the performance analysis of the TDFA, according to aspects of the present disclosure;

FIG. 6 is a flow chart of transmitting data between Earth and satellite over the OWC channel using the dual-hop system, according to aspects of the present disclosure;

FIG. 7A is a graph illustrating signal wavelength versus output power as a function of a thulium-doped fiber (TDF) length, according to aspects of the present disclosure;

FIG. 7B is a graph illustrating signal wavelength versus output power as a function of Tm³⁺ concentration, according to aspects of the present disclosure;

FIG. 8A is a graph illustrating signal wavelength versus gain of the dual-hop system, according to aspects of the present disclosure;

FIG. 8B is a graph illustrating signal wavelength versus noise figure (NF) of the dual-hop system, according to aspects of the present disclosure;

FIG. 9A is a graph illustrating pump wavelength versus output power of the dual-hop system, according to aspects of the present disclosure;

FIG. 9B is a graph illustrating pump wavelength versus gain of the dual-hop system, according to aspects of the present disclosure;

FIG. 10A is a graph illustrating signal wavelength versus output power of the dual-hop system considering pair-induced quenching (PIQ), according to aspects of the present disclosure;

FIG. 10B is a graph illustrating signal wavelength versus gain of the dual-hop system considering PIQ, according to aspects of the present disclosure;

FIG. 11A is a graph illustrating signal wavelength versus gain of the dual-hop system at different TDF lengths, according to aspects of the present disclosure;

FIG. 11B is a graph illustrating signal wavelength versus gain of the dual-hop system at different Tm³⁺ concentrations, according to aspects of the present disclosure;

FIG. 12A is a graph illustrating signal wavelength versus gain of the dual-hop system as a function of signal power, according to aspects of the present disclosure;

FIG. 12B is a graph illustrating signal wavelength versus output power of the dual-hop system as a function of signal power, according to aspects of the present disclosure;

FIG. 13 is a graph illustrating signal wavelength versus amplified spontaneous emission (ASE) of the dual-hop system as a function of pump power, according to aspects of the present disclosure;

FIG. 14A is a graph illustrating range versus bit error rate (BER) for four channels using the dual-hop system obtained at 0.22 dB/m, according to aspects of the present disclosure;

FIG. 14B is a graph illustrating range versus BER for four channels using the dual-hop system obtained at 4 dB/m, according to aspects of the present disclosure;

FIG. 14C is a graph illustrating range versus BER for four channels using the dual-hop system obtained at 5 dB/m, according to aspects of the present disclosure;

FIG. 15A illustrates an eye diagram of a first channel (channel-1) obtained at atmospheric attenuation of 0.22 dB/km, according to aspects of the present disclosure;

FIG. 15B illustrates an eye diagram of the first channel (channel-1) obtained at atmospheric attenuation of 4 dB/km, according to aspects of the present disclosure;

FIG. 15C illustrates an eye diagram of the first channel (channel-1) obtained at atmospheric attenuation of 5 dB/km, according to aspects of the present disclosure;

FIG. 15D illustrates a constellation plot of the first channel (channel-1) obtained at atmospheric attenuation of 0.22 dB/km, according to aspects of the present disclosure;

FIG. 15E illustrates a constellation plot of the first channel (channel-1) obtained at atmospheric attenuation of 4 dB/km, according to aspects of the present disclosure; and

FIG. 15F illustrates a constellation plot of the first channel (channel-1) obtained at atmospheric attenuation of 5 dB/km, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a dual-hop earth-to-satellite optical wireless communication (OWC) system, also referred to as a system herein after, with an amplifier. In one example, the amplifier is a thulium-doped fiber amplifier (TDFA) integrated with the system to enhance communication efficiency. The system integrates TDFA as booster amplifier to overcome the challenges posed by atmospheric attenuation, turbulence, and pointing errors to ensure reliable and efficient data transmission.

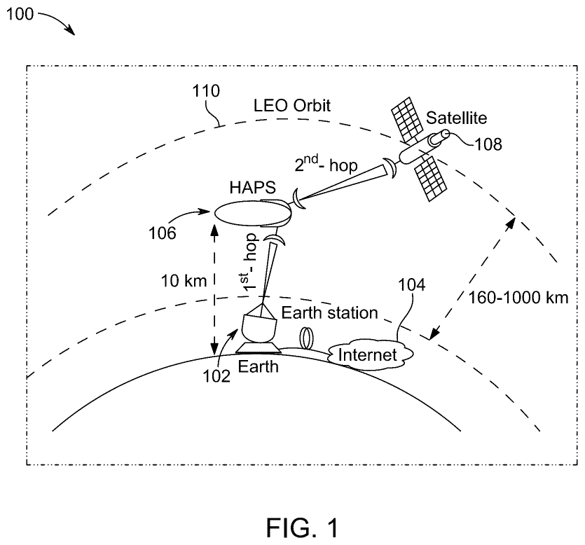

FIG. 1 represents a network diagram of a dual-hop system 100 for optical wireless communication (OWC) between a base station on Earth and satellite, according to aspects of the present disclosure. As shown in FIG. 1, the dual-hop system 100 is mainly implemented through an earth station 102, a high-altitude platform station (HAPS) 106 communicatively connected to the earth station 102, and a satellite 108 communicatively connected to the HAPS 106. The earth station 102 is a terrestrial radio station designed for extraplanetary telecommunication with a spacecraft, or reception of radio waves from astronomical radio sources. The earth station 102 may be located either on the surface of the Earth, or in Earth's atmosphere. In one aspect the earth station 102, alternatively referred to as a base station 102, is positioned on the Earth's surface, equipped with a high-power thulium-doped fiber amplifier (TDFA) (not shown in FIG. 1) used as a booster amplifier. Utilization of the TDFA as a booster amplifier ensures that the data-modulated optical signal, when transmitted, can overcome the atmospheric attenuation typically encountered in OWC links, especially the OWC links, which are influenced by weather-related disturbances. In one implementation, a communication medium is the Internet 104. The HAPS 106 is an aircraft or airship situated in the stratosphere (from 17 km to 22 km above the ground) and can be used for providing wireless communications and other applications. In one aspect, the HAPS 106 is located at an altitude of about 10 km above the Earth's surface. The signal amplified by the TDFA is transmitted to the HAPS 106 using a telescope.

In an aspect, the HAPS 106 functions as an all-optical amplify and forward (OAF) relay in the dual-hop system 100. The HAPS 106 is equipped with a telescope that is configured to receive the optical signals and a high-gain TDFA that serves as an in-line amplifier. In one aspect, the OWC link is less affected by weather disturbances beyond the troposphere. Therefore, the HAPS 106 is mainly configured to amplify the gain of the signal, instead of boosting the power of the signal. Accordingly, the high-gain TDFA is implemented at the HAPS 106 to improve signal quality.

After the signal amplification at the HAPS 106, the amplified signal is further transmitted to the satellite 108. A low Earth orbit (LEO) 110 is an orbit that is relatively close to Earth's surface, typically at an altitude of less than 1000 km, ranging as low as 160 km above Earth. The LEO satellites 108 are the satellites which are positioned to orbit along the LEO 110 in a proximity to Earth's surface at an altitude ranging from as low as 200 km to less than 1000 km above the Earth. The LEO satellite 108 receives and processes the amplified signals from the HAPS 106. The placement of the earth station 102, the HAPS 106, and the LEO satellite 108 and the configuration of the dual-hop system 100 characterized by signal amplification ensure efficient and reliable communication, overcoming the challenges posed by atmospheric and spatial factors.

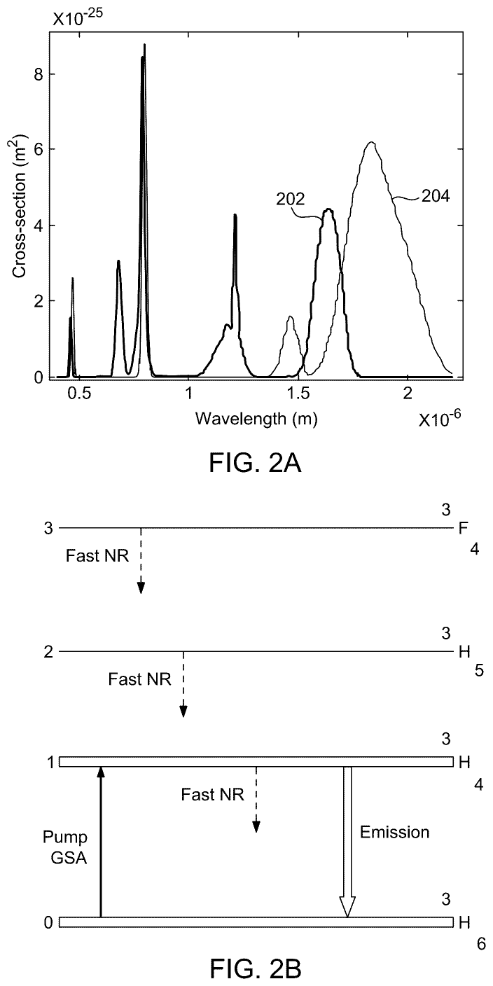

FIG. 2A illustrates a graphical representation of an absorption spectrum and an emission spectrum of Tm³⁺. Curve 202 illustrates absorption spectrum of the Tm³⁺. The absorption spectrum refers to a measure of how effectively a material can absorb the energy of incident radiation at a specific wavelength. A larger absorption spectrum indicates a higher probability of absorption, while a smaller spectrum suggests a lower probability. Curve 204 illustrates Tm³⁺ emission spectrum of the Tm³⁺. The emission spectrum represents the efficiency of the material in releasing energy as radiation.

From FIG. 2A, it is evident that Tm³⁺ possesses several pump absorption bands, each leading to emissions at distinct wavelengths. Commonly, pumping at wavelengths of 793 nm, 1000 nm, 1064 nm, 1200 nm, 1400 nm, 1570 nm, 1600 nm, and 1840 nm is implemented. However, in the present embodiment, a 1210 nm wavelength is utilized for pumping the thulium-doped fibers (TDFs) in both stages.

FIG. 2B illustrates the energy level diagram of Tm³. Thulium has a simple energy level scheme with inherently two levels that is, 3H₆ level serving as the ground energy state, and ³H₄ as a first excited manifold, as shown in FIG. 2B. The energy level diagram of Tm³ includes various sub-energy levels, and the transitions between these sub-energy levels are not fully resolved at room temperature. Pumping and laser transitions occur between the various sub-energy levels of each manifold. The predominant transition facilitating lasing around the 1800 nm wavelength occurs between the ³H₆ level-³H₄ level.

The rate equations formulated in accordance with the transition may be expressed by the following equations:

$$\frac{{dN}_{1}}{dt} = - ( {W}_{10} + \frac{{P}_{p} {σ}_{ap}}{{hf}_{p}} + \frac{{P}_{s} {σ}_{as}}{{hf}_{s}} ) {N}_{1} + {W}_{21} {N}_{2} + \frac{{P}_{s} {σ}_{as}}{{hf}_{s}} {N}_{3} . \qquad ( 1 )$$

$$\frac{{dN}_{3}}{dt} = \frac{{P}_{s} {σ}_{as}}{{hf}_{s}} {N}_{1} - ( {W}_{30} + \frac{{P}_{p} {σ}_{ap}}{{hf}_{p}} + \frac{{P}_{s} {σ}_{as}}{{hf}_{s}} ) {N}_{3} + {W}_{43} {N}_{4} . \qquad ( 2 )$$

$$\frac{{dN}_{5}}{dt} = \frac{{P}_{p} {σ}_{ap}}{{hf}_{p}} {N}_{3} + ( {W}_{50} + {W}_{52} ) {N}_{5} . \qquad ( 3 )$$

During the experiments for developing a numerical model of the dual-hop system 100, the amplified spontaneous emission (ASE) and fiber attenuation were neglected. By neglecting the ASE and fiber attenuation, the propagation equations of a pump and signal along the TDF in the z-direction can be written as:

$$\frac{{dP}_{p}}{dz} = - {Γ}_{p} ( {σ}_{ap} {N}_{0} - {σ}_{ap} {N}_{1} - {σ}_{ap} {N}_{3} ) {P}_{p} ( z ) . \qquad ( 4 )$$

$$\frac{{dP}_{s}}{dz} = - {Γ}_{s} ( {σ}_{es} {N}_{3} - {σ}_{as} {N}_{1} - {σ}_{01} {N}_{0} ) {P}_{s} ( z ) . \qquad ( 5 )$$

The symbols notations used in the equation 1-equation 5 are defined in Table 1.

TABLE 1
Different symbols used in eq. (1)-eq. (5)

| Sr. | | |
|---|---|---|
| No | Symbol | Description |
| 1 | Nᵢ | Population densities at i level |
| 2 | Pₚ, Pₛ | Pump and signal powers |
| 3 | hfₚ, hfₛ | Pump and signal photon energies |
| 4 | σₐₚ, σₐₛ | Absorption cross-section of the pump and signal |
| 5 | σₑₛ | Emission cross-section of signal |
| 6 | σ₀₁ | Transition cross-section from background level to |
| | | the first excited level |
| 7 | Γₚ, Γₛ | Overlap integral of pump and signal |
| 8 | Wᵢⱼ | Radiative transition rates from level i to level j |
| 9 | h | Plank's constant |

In addition to the length of the TDF and the concentration of Tm³⁺, the selection of an appropriate pumping scheme significantly impacts the overall performance, particularly power conversion efficiency (PCE) and cost of TDFAs. Hence, determining an optimal pumping configuration is a primary step before the defining of other parameters.

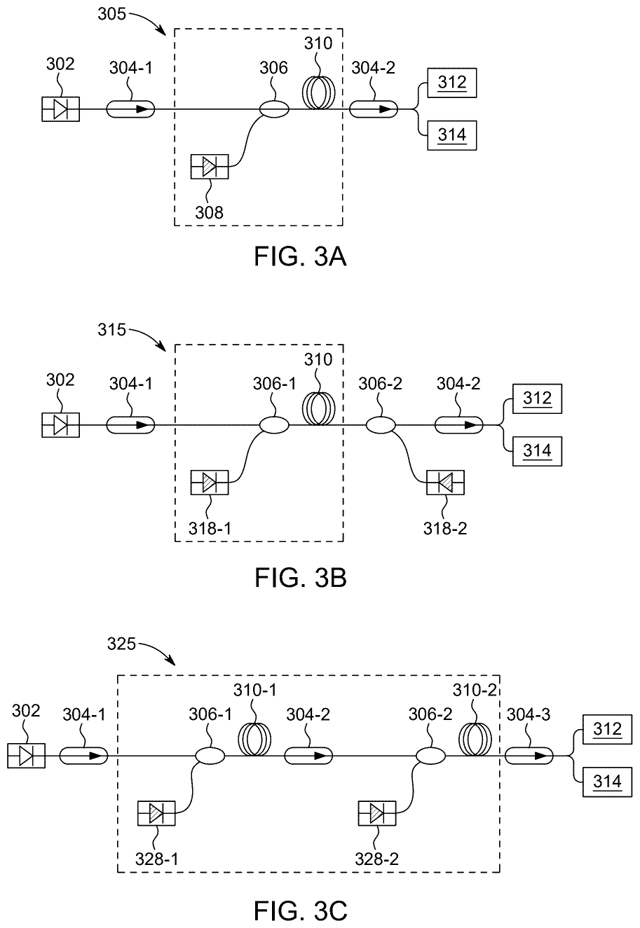

FIGS. 3A-3C illustrate the various pumping schemes employed for pumping Tm³⁺. In accordance with the present embodiment, the optimization of the pumping configuration is facilitated through evaluating PCE values, derived from the graphs plotting pump power against output power. The various pumping configurations include a forward pumping configuration, a bidirectional pumping configuration, and a dual-stage pumping configuration.

FIG. 3A illustrates the forward pumping configuration of a TDFA 305, in accordance with the present embodiment. The forward pumping configuration mainly includes a continuous wave (CW) fiber laser 302, a first isolator (ISO) 304-1, a fiber coupler 306, a pump 308, the TDF 310, a second isolator 304-2, an optical power meter (OPM) 312, and an optical spectrum analyzer (OSA) 314. In one aspect, the CW fiber laser 302 is configured to generate a signal laser beam. The first isolator (ISO) 304-1 is connected to the CW fiber laser 302. The first isolator (ISO) 304-1 is configured to receive the generated signal laser beam from the CW fiber laser 302 and generates an isolated signal. The first isolator (ISO) 304-1 is configured to prevent the signal laser beam from reflecting back into the CW fiber laser 302. The isolator uses the magneto-optic rotation phenomenon to protect the laser source from reflections that can damage the operation of the laser system. The first isolator (ISO) 304-1 transmits the isolated signal to the fiber coupler 306. The pump 308 is configured to generate a pumped laser beam. The pump 308 is configured to transfer energy from an external source into a gain medium of the TDFA.

The fiber coupler 306 is connected to the first isolator (ISO) 304-1 and the pump 308. The fiber coupler 306 is configured to receive the isolated signal from the first isolator (ISO) 304-1 and the pumped laser beam from the pump 308 simultaneously. The fiber coupler 306 is configured to combine the received signal and the pumped laser beam and generate a combined laser beam (combined signal). The fiber coupler 306 is a dichroic fiber coupler in one instance. The fiber coupler 306 is used to combine the pumped laser beam and a signal input for the TDF 310-1, or to remove residual pump signal after the TDF 310-1. In one example, the pump 308 can be a fiber coupled diode laser coupled to the fiber coupler 306, and can be configured to operate at 1210 nm. The combined signal is transmitted to the TDF 310 from the fiber coupler 306. The TDF 310 amplifies the signal further and transmits the amplified signal to the second isolator 304-2.

The second isolator 304-2 is configured to receive the amplified laser beam from the TDF 310. The second isolator 304-2 generates an isolated amplified laser beam. The second isolator 304-2 is configured to ensure the unidirectional operation of the amplified laser beam. The second isolator 304-2 is configured to transmit the amplified laser beam to the OPM 312 and the OSA 314.

The signal is evaluated at the OPM 312 and the OSA 314. The OPM 312 can measure both the absolute power level and the relative power level of light in the fiber. The OPM 312 is commutatively connected to the second isolator 304-2 and receives the isolated amplified laser beam from the second isolator 304-2. The OPM 312 is configured to measure amplitude of the received amplified laser beam.

The OSA 314 is an instrument designed to measure and display the distribution of power of an optical source over a specified wavelength span. The OSA 314 is connected to the second isolator 304-2. The OSA 314 is configured to receive the isolated amplified laser beam from the second isolator 304-2. The OSA 314 is configured to measure a frequency response of the received amplified laser beam. The OSA 314 is configured to measure the spectrum content of the received laser beam.

FIG. 3B illustrates a bidirectional pumping configuration of TDFA 315, in accordance with the present embodiment. FIG. 3B should be viewed in conjunction with FIG. 3A. In some embodiments, a first pump 328-1 of the TDFA 315 is similar to the pump 308 of FIG. 3A. In a bidirectional pumping configuration, the first isolator 304-1 is pumped by the first pump 318-1, and the second isolator 304-2 is pumped by a second pump 318-2 bidirectionally (e.g., in a direction opposite to the first pump 318-1).

FIG. 3C illustrates a dual-stage pumping configuration of a TDFA 325, in accordance with the present embodiment. FIG. 3C should be viewed in conjunction with FIG. 3A. In some embodiments, some of the components of the TDFA 325 are similar to that of the TDFA 305 of FIG. 3A. For example, a first pump 328-1 of the TDFA 325 is similar to the pump 308 of FIG. 3A. In the dual-stage pumping configuration, there are two TDFs (a first TDF 310-1, a second TDF 310-2), also combinedly referred to as 310, in the TDFA 325. The signal transmitted by the first isolator 304-1 is pumped by the first optical pump 328-1 during a first pumping stage. A pumped-up signal generated by the first fiber coupler 306-1 is transmitted to the first TDF 310-1. From the first TDF 310-1, the signal is sent to a second pumping stage for further amplification. At the second pumping stage, the signal is pumped by the second optical pump 328-2. A pumped-up signal is transmitted, from the second fiber coupler 306-2, to the second TDF 310-2.

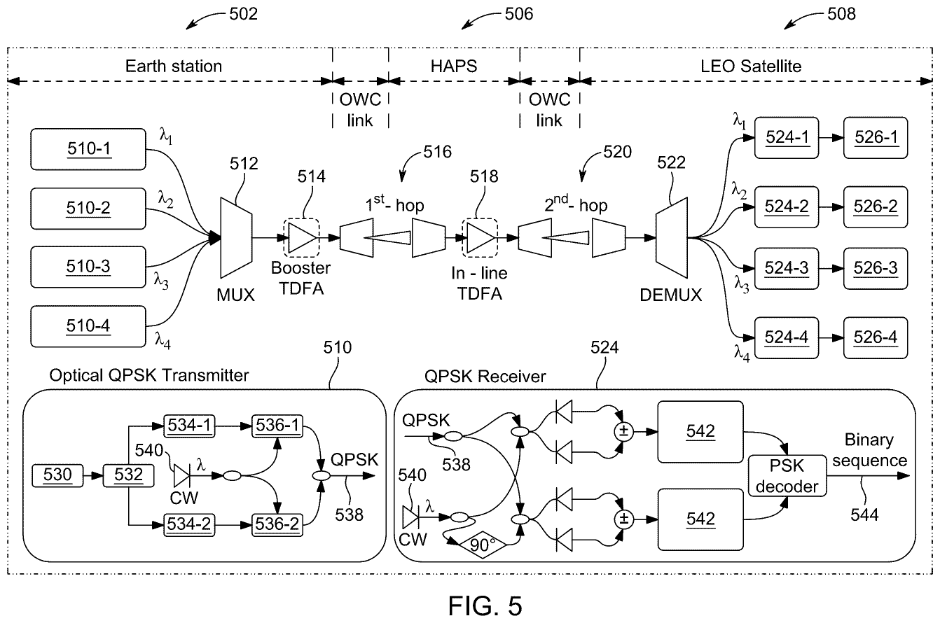

As described with respect to FIG. 1, the base station 102 is configured to wirelessly transmit the amplified signal to the HAPS 106 installed at a specified altitude from the surface of Earth. At the second hop, the HAPS 106 is configured to further transmit the output optical signal to the satellite wirelessly. Each of the hops includes a TDFA, and in an example, the TDFA may be configured using the dual-stage pumping configuration of FIG. 3C. For example, the first TDFA (e.g., TDFA 514 of FIG. 5) is installed in the base station located on the surface of Earth and is configured as the dual-stage pumping TDFA 325 of FIG. 3C. The first TDFA (acting as a booster amplifier) is configured to amplify an input optical signal to generate the amplified signal. The second TDFA (e.g., TDFA 518 of FIG. 5) is installed in the HAPS 106 and is configured as the dual-stage pumping TDFA 325 of FIG. 3C. The second TDFA (acting as an in-line amplifier) is configured to compensate for the attenuation of the amplified signal from the base station by amplifying the amplified signal to generate an output optical signal.

Accordingly, the first TDFA, the second TDFA, the first set of optical pumps and the second set of optical pumps are further configured based on a mode of operation of the first TDFA and the second TDFA to provide a power amplification, or gain in amplifying the input optical signal, that satisfies a specified criterion.

In one aspect, the specified criterion includes an output power provided by the first TDFA (e.g., TDFA 514), or a gain provided by the second TDFA (e.g., TDFA 518), being the highest among output power or gain provided for various wavelengths of the input optical signal.

In one aspect, the first TDFA (e.g., TDFA 518) is configured to operate in a booster amplifier mode of operation, and the second TDFA (e.g., TDFA 518) is configured to operate in an in-line amplifier of operation.

To ensure an unbiased comparison, identical values of pump power, TDF length, and Tm³⁺ concentration are maintained across all configurations. The configuration yielding the highest PCE is identified as the most efficient and is thus selected for further experimentation and implementation.

In one aspect, the length of the TDF of the first TDFA 514 is configured to provide the power amplification by the first TDFA 514 that satisfies the specified criterion. Similarly, the length of the TDF of the second TDFA 518 is configured to provide the gain that satisfies the specified criterion.

In one aspect, the TDF of the first TDFA 514 has a first thulium concentration amount that enables the first TDFA 514 to provide the power amplification that satisfies the specified criterion. Likewise, the TDF of the second TDFA 518 has a second thulium concentration amount that enables the second TDFA 518 to provide the gain that satisfies the specified criterion.

In one aspect, the first set of optical pumps of the first TDFA 514 and the second set of optical pumps of the second TDFA 518 are configured to input light of a specified wavelength. The specified wavelength is one of the different wavelengths of the input light above which a degree of change in output power or the gain of the first TDFA 514 or the second TDFA 518 is below a specified threshold.

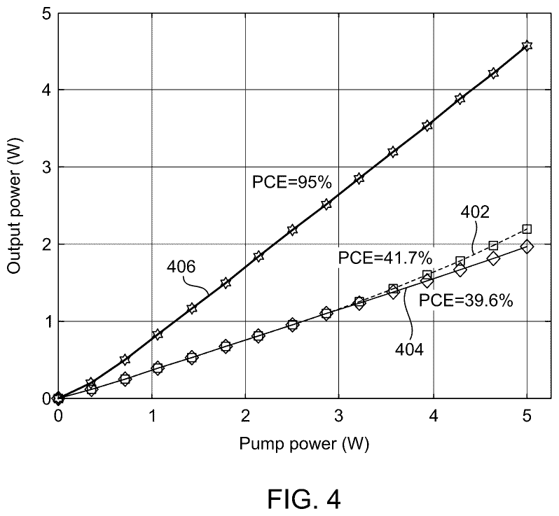

FIG. 4 displays a graphical representation of the relationship between the pump power and the output power for various pumping configurations, in accordance with the present embodiment. For the forward pumping configuration, as depicted by curve 402, the plot is derived from parameters including a TDF length of 3 m, a Tm³⁺ concentration of 25×10²⁴ m⁻³, a signal power of 0 dBm, and a pump power of 5 W. In the bidirectional pumping configuration, as depicted by curve 404, the same TDF length, Tm³⁺ concentration, and signal power are used, with a pump power of 5W distributed equally at 2.5 W for each pump. In the dual-stage pumping configuration, as depicted by curve 406, a plot is obtained with parameters of a TDF length split into two sections of 1.5 m (e.g., 1.5 m for each TDF of the two TDFs 310), a Tm³⁺ concentration of 12.5×10²⁴ m⁻³ for each TDF, a signal power of 0 dBm, and a total pump power of 5 W, divided evenly at 2.5 W for each pump.

The consistent signal and pump wavelengths used across all pumping configurations are 1807 nm and 1210 nm, respectively. From FIG. 4, it is evident that the forward pumping configuration, the bidirectional pumping configuration, and the dual-stage pumping configuration offer power conversion efficiencies (PCEs) of 41.7%, 39.6%, and 95%, respectively. PCE is expressed as the ratio of output power to input power. Consequently, the dual-stage pumping configuration appears superior, characterized by its exceptional PCE, marking it as the optimal pumping approach.

As described with reference to FIG. 5, the first TDFA 514 and the second TDFA 518 are employed as the booster amplifier and the in-line amplifier, respectively, and are based on the dual-stage pumping configuration of FIG. 3C. In the dual-stage pumping configuration, the TDFs may be pumped using semiconductor laser diodes (fiber-coupled laser diode). However, the fiber laser-based pump sources can also be employed as an alternative. Signal values are evaluated using a plurality of analyzers, such as the dual-port wavelength division multiplexing (WDM) analyzer, optical power meter (OPM), and optical spectrum analyzer (OSA) are utilized to observe and assess the results.

FIG. 5 demonstrates a system-level performance analysis of the developed TDFA (first TDFA 514, and the second TDFA 518) employed in the dual-hop system 100. During performance analysis, four continuous-wave (CW) signals, each with powers of 0 dBm and wavelengths 21=1800 nm, 22=1800.8 nm, 23=1801.6 nm, and 24=1802.4 nm, are modulated with electrical quadrature phase shift keying (QPSK) signals at a rate of 26 Gbps at the earth station 502. The QPSK is a form of phase shift keying (PSK) in which two bits are modulated at once, selecting one of four possible carrier phase shifts (0, 90, 180, or 270 degrees). The CW signals are transmitted using four optical QPSK transmitters. A first signal with powers of 0 dBm and wavelengths λ₁=1800 nm is transmitted by a first optical QPSK transmitter 510-1. A second signal with powers of 0 dBm and wavelengths λ₂=1800.8 nm is transmitted by a second optical QPSK transmitter 510-2. A third signal with powers of 0 dBm and wavelengths λ₃=1801.6 nm is transmitted by a third optical QPSK transmitter 510-3. A fourth signal with powers of 0 dBm and wavelengths λ₄=1802.4 nm was transmitted by a fourth optical QPSK transmitter 510-4.

FIG. 5 also depicts a block diagram of the QPSK transmitter. The QPSK transmitter includes, but may not be limited to, a pseudorandom binary sequence (PRBS) generator 530, a PSK modulator 532, two M-ary modulators (534-1, 534-2), two Mach-Zehnder modulators (MZMs) (536-1, 536-2), and a QPSK module 538.

The PRBS generator 530 is implemented to generate a data stream, which is mapped by a QPSK encoder, for the QPSK modulation. The data stream is passed to 1024 sub-carriers. The PSK modulator 532 is a digital modulation process which conveys data by changing (modulating) the phase of a constant frequency carrier wave. The modulation is accomplished by varying the sine and cosine inputs at a precise time. The M-ary modulators (534-1, 534-2) are implemented to provide a type of digital modulation where instead of transmitting one bit at a time, two or more bits are transmitted simultaneously. This type of transmission results in reduced channel bandwidth. The MZM (536-1, 536-2) is an interferometric structure made from a material with a strong electro-optic effect, such as LiNbO₃, GaAs, and InP. Each of the MZMs (536-1, 536-2) is configured to receive an input signal from a CW laser source 540. In the MZM, applying electric fields to the arms results in changes to optical path lengths resulting in phase modulation. In the QPSK module 538 two bits are modulated at once, selecting one of four possible carrier phase shifts (0, 90, 180, or 270 degrees). The QPSK allows the signal to carry twice as much information as ordinary PSK using the same bandwidth.

After receiving the signal transmitted by the optical QPSK transmitters 510, the optical QPSK signals are then multiplexed by a multiplexer 512. The multiplexer 512 is configured to generate a combined optical signal, with an aggregate data rate of 104 Gbps. The multiplexer 512 transmitted the combined optical signal towards the booster TDFA 514. The booster TDFA 514 is configured to amplify the optical signal and is further configured to transmit the amplified optical signals towards the HAPS 506 over a first hop 516 of the OWC link. In an example, the first hop 516 has a 10 km range. In an aspect, an average optical power of the combined signal entering the transmitter telescope of the earth station 502 is 37 dBm.

Upon reaching the HAPS 506, the signal is received by an in-line TDFA 518, which acts as an optical amplify and forward (OAF) relay. The OAF relay is configured to allow an efficient transmission of signals between different nodes. In an aspect, the OAF relay is configured to amplify the received signal. The amplified signal possesses an average optical power of 31.5 dBm at the entry point of a transmitter telescope of the HAPS 506. The signal is then relayed over the second hop 520 of the OWC link spanning 990 km, directed towards a Low Earth Orbit (LEO) satellite 508. The optical signal power received by the telescope at the LEO satellite 508 is calculated according to the following relation:

$${P}_{r} = {P}_{t} {η}_{t} {{η}_{r} ( \frac{λ}{4 π L} )}^{2} {G}_{t} {G}_{r} {L}_{t} {L}_{r} , \qquad ( 6 )$$

where; Pₜ; Pᵣ; ηₜ; ηᵣ; λ, L, Gₜ; Gᵣ; Lₜ; and Lᵣ is transmitted power, received power, transmitter optics efficiency, receiver optics efficiency, operating wavelength, length of OWC link, transmitter telescope gain, receiver telescope gain, transmitter pointing loss and receiver pointing loss, respectively. In equation. 6, the receiver telescope gain is given by:

$${G}_{r} = {( \frac{π {D}_{r}}{λ} )}^{2} , \qquad ( 7 )$$

where, Dᵣ is the receiver telescope diameter. It may be observed from equations that the receiver telescope gain depends on the receiver telescope diameter. Thus, smaller the telescope diameter, the less power received by it and vice versa. Both of the OWC links are modeled using a Gamma-Gamma channel model. The Gamma-Gamma channel model is a statistical model which is used to analyze the reliability of communication channels. It is a generalization of the classical Shannon model, which assumes a marked point process for failure times. The probability density function (PDF) of signal intensity fluctuations owing to atmospheric turbulence of OWC links is governed by Gamma-Gamma distribution, can be given as:

$$p ( I ) = \frac{2 {( αβ )}^{\frac{α + β}{2}}}{Γ ( α ) Γ ( β )} {I}^{( α + β ) / 2 - 1} {K}_{α - β} ( 2 \sqrt{αβ I} ) , \qquad ( 8 )$$

where, K_{α-β} is the Bessel function of nₜₕ-order and Γ(·) is the Gamma function in terms of propagation distance z over OWC links as:

$$Γ ( z ) = {\int }_{0}^{∞} exp ( - t ) {t}^{z - 1} dt . \qquad ( 9 )$$

In the case of planar wave propagation, the parameters a and b, representing large- and small-scale eddies of the scattering process, respectively are given by the following expressions:

$$α = {[ exp ( \frac{0.49 {σ}_{l}^{2}}{{( 1 + 1.11 {σ}_{l}^{2.4} )}^{1.17}} ) - 1 ]}^{- 1} , \qquad ( 10 )$$

$$β = {[ exp ( \frac{0.51 {σ}_{l}^{2}}{{( 1 + 0.69 {σ}_{l}^{2.4} )}^{0.833}} ) - 1 ]}^{- 1} , \qquad ( 11 )$$

where, σₗ²=1.23 Cₙ² k^{7/6}L^{11/6} is log intensity variance describing the strength of atmospheric turbulence, L is the length of OWC link in km, k=2π/λ is the wave number, and Cₙ² is the refractive index structure parameter whose values can vary over time even for a specific link due to the complex dynamics of the weather. Normally, the value of Cₙ² varies from 10⁻¹⁷ for weak turbulence to 10⁻¹² for strong turbulence. The signal is then demultiplexed by a demultiplexer 522. After demultiplexing, the individual optical QPSK signals, including λ₁, λ₂, λ₃, and λ₄, are detected by a first QPSK receiver 524-1, a second QPSK receiver 524-2, a third QPSK receiver 524-3, and a fourth QPSK receiver 524-4, combinedly referred as to the QPSK receiver 524. At the QPSK receivers, optical to electrical conversion takes place based on the principle of homodyne detection. The structure of the QPSK receiver 524 is shown in FIG. 5. The QPSK receiver 524 includes a QPSK module 538, and a CW input transmitted further with 90 degrees phase shift to a M-ary threshold detector 542. The M-ary threshold detector 542 is designed to discriminate between the M levels of an M-ary code. The signals having discriminated M levels are then sent to a PSK decoder 544 for demodulation of the signal.

After PSK decoding, the retrieved binary data signals are passed on to the Bit Error Rate (BER) test sets 526 for BER calculation as shown in FIG. 5. BER is a measure of telecommunication signal integrity based on the quantity or percentage of transmitted bits that are received incorrectly. The important simulation parameters used in this work are shown in Table 2.

TABLE 2
Important simulation parameters.

| Sr. | | | |
|---|---|---|---|
| No | Parameter | Value | |
| 1 | Data rate (each channel) | 26 | Gbps |
| 2 | Range of first OWC link (first-hop) | 10 | km |
| 3 | Range of second OWC link (second-hop) | 990 | km |
| 4 | Atmospheric attenuation of first OWC link | 5 | dB/km |
| 5 | Atmospheric attenuation of second OWC link | 0.22 | dB |
| 6 | Refractive index structure parameter (Cₙ²) of both | 5 × 10−¹² m^{-2/3} | |
| | OWC links | | |
| 7 | Transmitter and receiver aperture diameter | 5 and 10 cm | |
| 8 | Beam divergence | 2 | mrad |
| 9 | Pump wavelength | 1210 | nm |
| 10 | Pump power | 2.5 | W |
| 11 | Core radius | 1.3 | μm |
| 12 | Numerical aperture | 0.3 | |
| 13 | Doping radius | 1.3 | μm |
| 14 | Signal attenuation | 0.1 | dB |
| 15 | Pump attenuation | 0.15 | dB |
| 16 | Responsivity of PIN | 0.9 | A/W |
| 17 | Temperature | 300 | K |

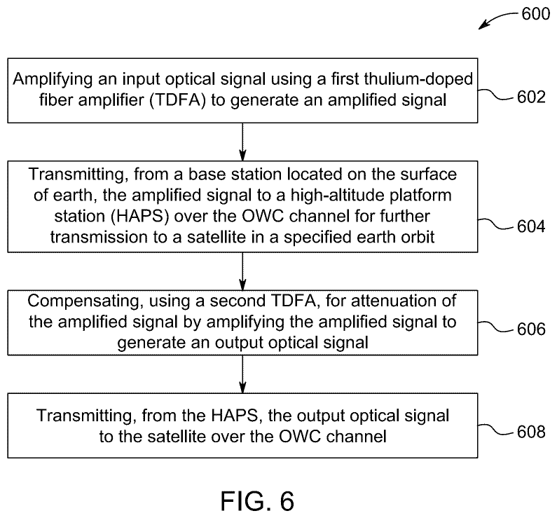

FIG. 6 is a flow chart 600 of transmitting data between Earth and satellite over the OWC channel using the dual-hop system 100, according to aspects of the present disclosure.

Step 602 includes amplifying an input optical signal using the first TDFA (e.g., TDFA 514) to generate an amplified signal.

Step 604 includes transmitting, from a base station located on the surface of Earth, the amplified signal to the HAPS 106 over the OWC channel for further transmission to a satellite in a specified earth orbit, wherein the HAPS 106 is installed at a specified altitude from the surface of Earth.

Step 606 includes compensating, using the second TDFA (e.g., TDFA 518), for attenuation of the amplified signal by amplifying the amplified signal to generate an output optical signal.

Step 608 includes transmitting, from the HAPS 106, the output optical signal to the satellite over the OWC channel.

In an aspect, the flow chart 600 further includes a step of amplifying using the first TDFA and the second TDFA includes configuring the first TDFA or the second TDFA based on a mode of operation of the first TDFA and the second TDFA to provide an output power or a gain that satisfies a specified criterion.

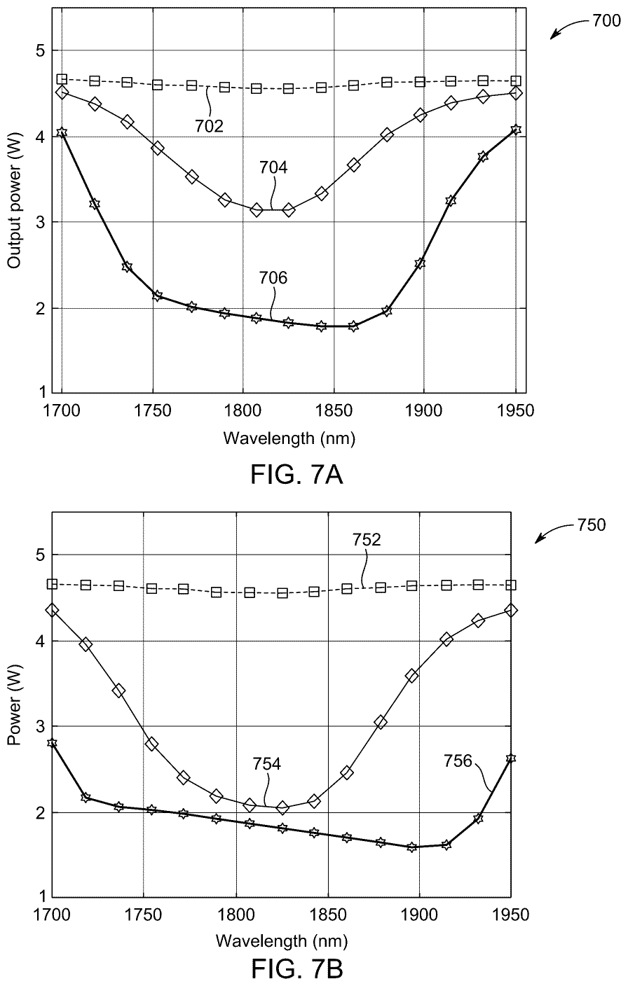

FIGS. 7A-10B illustrate optimization of various parameters of a TDFA for operating as a booster amplifier. FIG. 7A-FIG. 7B represent the calculated output power of the TDFA 325 for varying signal wavelengths, TDF lengths (L), and Tm³⁺ concentrations, given a signal power of 0 dBm and a pump power of 5 W (2.5 W for each pump).

FIG. 7A is a graph 700 illustrating signal wavelength versus output power as a function of the TDF length. Curve 702 represents the output power of the TDFA 325 when L=1.5 m. Curve 704 represents the output power of the TDFA 325 when L=2.5 m, and Curve 706 represents the output power of the TDFA 325 when L=3.5 m. As depicted in FIG. 7A, the peak output power of the TDFA 325 in booster mode (e.g., first TDFA 514), which is 4.6 W, occurs at a signal wavelength of 1807.143 nm, with a TDF length of 3 m (e.g., 1.5 m for each TDF 310-1 and 310-2), and a Tm³⁺ concentration of 12.5×10²⁴ m⁻³ for each TDF, as depicted by the curve 702. Consequently, the TDF length of 3 m is identified as a defined length for achieving the maximum output power.

Further analysis involving different Tm³⁺ concentrations while maintaining the optimized TDF length, is illustrated in FIG. 7B. FIG. 7B is a graph 750 illustrating signal wavelength versus output power as a function of Tm³⁺ concentration. Curve 752 represents the output power of the TDFA 325 when Tm³⁺ concentration is 12.5×10²⁴ m⁻³. Curve 754 represents the output power of the TDFA 325 when Tm³⁺ concentration is 25×10²⁴ m⁻³ for each TDF. Curve 756 represents the output power of the TDFA 325 when Tm³⁺ concentration is 37.5×10²⁴ m⁻³ for each TDF.

FIG. 7B indicates that the highest output power of the TDFA 325 is attained at the Tm³⁺ concentration of 12.5×10²⁴ m⁻³ for each TDF. The distinctive shape of the plots in FIG. 7A-FIG. 7B attributed to the interplay between the absorbed pump power and its subsequent conversion to a higher wavelength to amplify the signal. The specific contour of these plots results from the equilibrium between the absorption of the amplified signal and the gain derived from pump conversion.

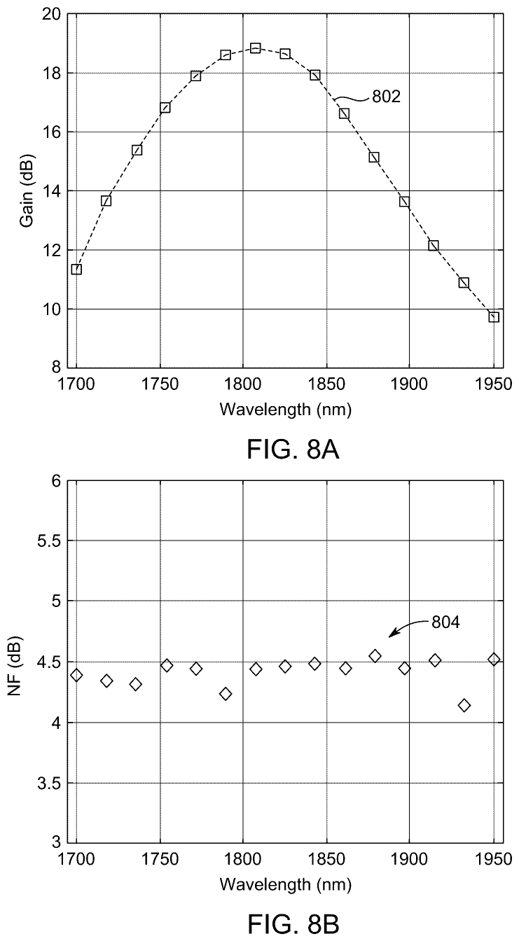

FIG. 8A-FIG. 8B display a relationship between signal wavelength and gain, as well as between signal wavelength and noise figure (NF), utilizing optimized parameters with a signal power of 0 dBm and a pump power of 5 W (e.g., 2.5 W for each pump 328-1 and 328-2 of the dual-stage pumping configuration of FIG. 3C). FIG. 8A is a graph illustrating signal wavelength versus gain of the dual-hop system 100. Curve 802 represents the gain of the TDFA 325.

FIG. 8B is a graph illustrating signal wavelength versus noise figure (NF) of the dual-hop system 100. Curve 804 represents the NF of the TDFA 325. From FIG. 8A, as depicted by curve 802, it is evident that the maximum gain of 18.8 dB is realized at a signal wavelength of 1807.143 nm. Correspondingly, FIG. 8B illustrates, as depicted by curve 804, that a NF of 4.44 dB is obtained at the same signal wavelength of 1807.143 nm, and a NF below 4.6 dB is achieved throughout the 1700-1950 nm wavelength range.

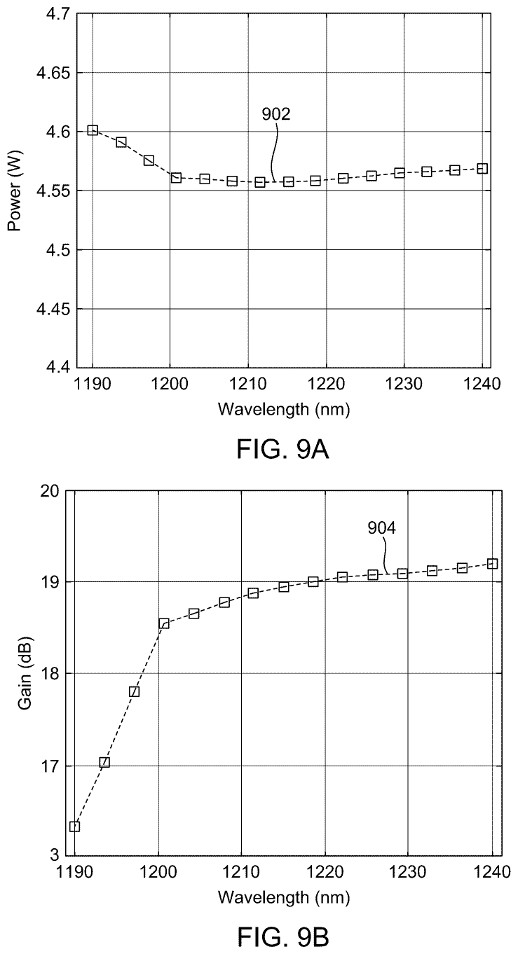

The influence of variations in pump wavelength on the output power and gain of the TDFA is examined in FIG. 9, while maintaining optimized parameters for signal wavelength, pump power, and signal power at 1807.143 nm, 5 W (2.5 W for each pump), and 0 dBm, respectively.

FIG. 9A is a graph illustrating pump wavelength versus output power of the TDFA. Curve 902 represents the output power of the TDFA 325.

As indicated in FIG. 9A, curve 902 depicts that the TDFA's output power diminishes within the 1190-1200 nm wavelength range and stabilizes for wavelengths exceeding 1200 nm. This pattern can be attributed to the absorption spectra and the emission spectra of Tm³⁺ depicted in FIG. 2A. Tm³⁺ exhibits maximum absorption around 1210 nm and simultaneously absorbs a portion of the amplified signal, as outlined in the absorption spectrum in FIG. 2A. The amplified signal achieves higher gain as more pump is absorbed, corroborated by the emission spectra in FIG. 2A, which presents a positive slope within the amplified signal wavelength range of interest. The equilibrium between the amplified signal's absorption and the gain it receives from the specific pump wavelength results in the observed behaviour in FIG. 9A. In an example, a pump wavelength (e.g., 1210 nm) above which a degree of change in the output power or the gain is below a specified threshold is selected as the wavelength of the light input by the optical pump.

FIG. 9B is a graph illustrating pump wavelength versus gain of the TDFA. Curve 904 represents the gain of the TDFA 325. FIG. 9B, through curve 904, reveals that the TDFA's gain ascends incrementally within the 1190-1205 nm wavelength range before reaching a saturation point beyond 1205 nm, where no significant increase in gain is noted. The trend is again rationalized by referring to the absorption and emission spectra of Tm³⁺ displayed in FIG. 2A. The absorption of pump photons escalates progressively within the 1190-1205 nm wavelength range, peaking around 1210 nm. This leads to a corresponding rise in the TDFA's gain within this range. Post wavelength 1210 nm, the absorption of pump photons begins to decline, instigating gain saturation.

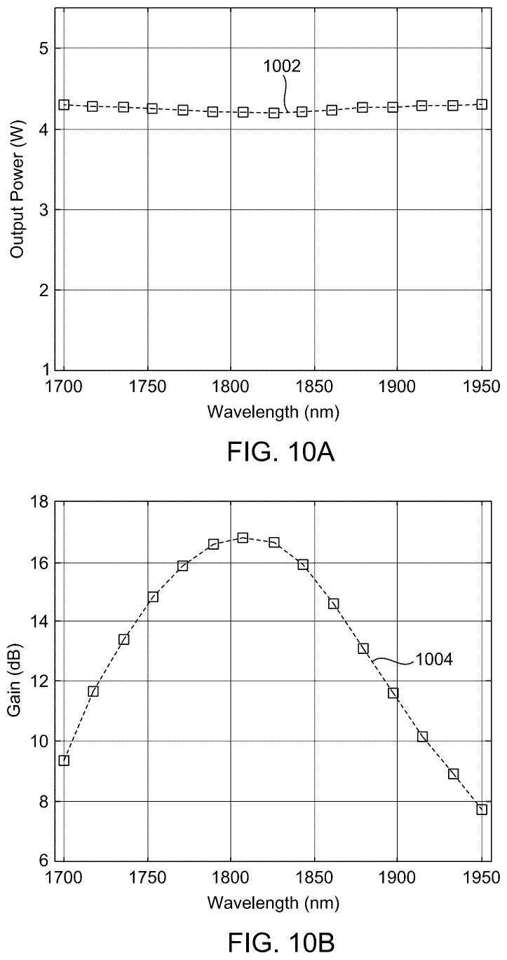

FIG. 10A-FIG. 10B show the impact of pair-induced quenching (PIQ) on the TDFA's output power and gain. This assessment is conducted with the optimized parameters, maintaining the pump and signal powers at 5 W (2.5 W for each pump) and 0 dBm, respectively. Cross-relaxation (CR) and homogeneous up-conversion (HUC) coefficients are set at 18×10²⁴ m⁻³ and 0.51×10²⁴ m⁻³, respectively, to evaluate the influence of PIQ.

FIG. 10A is a graph illustrating signal wavelength versus output power of the dual-hop system 100 considering pair-induced quenching (PIQ). Curve 1002 shows the output power of the TDFA 325. As observed by curve 1002 of FIG. 10A, when accounting for PIQ, there is a reduction of 0.4 W in the TDFA's output power.

FIG. 10B is a graph illustrating signal wavelength versus gain of the dual-hop system 100 considering PIQ. Curve 1004 shows the gain of the TDFA 325. Curve 1004 of FIG. 10B reveals an approximate 2 dB decline in the peak gain of the TDFA at 1807.143 nm due to the inclusion of PIQ. FIG. 10A-FIG. 10B confirm that PIQ adversely impacts the TDFA's performance, leading to reductions in both gain and output power.

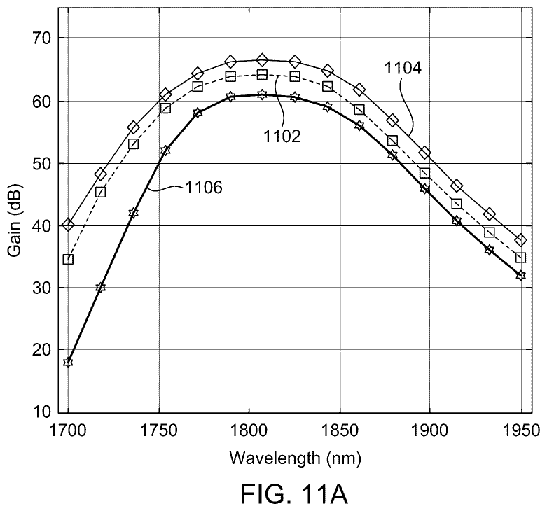

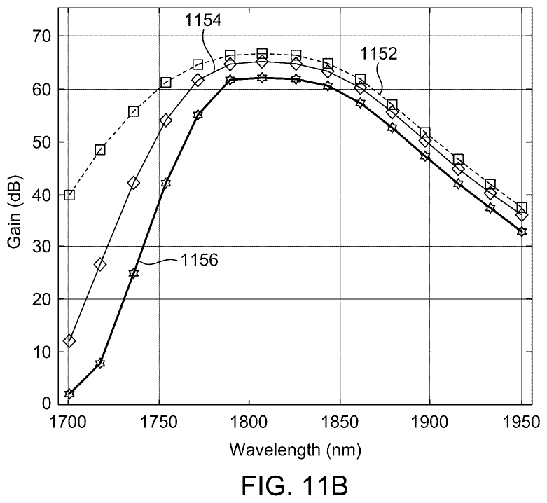

FIGS. 11A-13 illustrate optimization of various parameters of a TDFA for operating as an in-line amplifier. FIG. 11A-FIG. 11B show the gain evolution of the TDFA (acting as the in-line amplifier) by altering the signal wavelength at various TDF lengths and Tm³⁺ concentrations, with a signal power of −35 dBm and pump power of 5 W (2.5 W for each pump).

FIG. 11A is a graph illustrating signal wavelength versus gain of the dual-hop system 100 at different TDF lengths. Curve 1102 shows the gain of the TDFA 325 as an inline amplifier (e.g., TDFA 518) when TDF length is 3 m. Curve 1104 shows the gain of the TDFA 325 when TDF length is 6 m. Curve 1106 shows the gain of the TDFA 325 when TDF length is 9 m. FIG. 11A depicts that the TDFA attains its peak gain of 66.6 dB at 1807.143 nm with a TDF length and Tm³⁺ concentration of 12 m (6 m for each TDF 310-1 and 310-2) and 25×10²⁴ m⁻³ for each TDF, respectively. Consequently, a 12 m TDF length is identified as optimal for achieving the maximum gain.

Furthermore, the gain diminishes progressively when the TDF length is extended beyond this optimal point, a trend attributed to a reduction in population inversion. In a similar vein, plots contrasting signal wavelength with gain, based on varying Tm³⁺ concentrations and considering the optimized TDF length, are examined.

FIG. 11B is a graph illustrating signal wavelength versus gain of the dual-hop system 100 at different Tm³⁺ concentration. Curve 1152 shows the gain of the TDFA 325 when Tm³⁺ concentration is 25×10²⁴ m⁻³. Curve 1154 shows the gain of the TDFA 325 when Tm³⁺ concentration is 50×10²⁴ m⁻³. Curve 1156 shows the gain of the TDFA 325 when Tm³⁺ concentration is 75×10²⁴ m⁻³.

FIG. 11B indicates that the apex of the TDFA gain, standing at 66.6 dB, is attained at a Tm³⁺ concentration of 25×10²⁴ m⁻³ for each TDF. The Tm³⁺ concentration of 25×10²⁴ m⁻³ concentration is therefore deemed as a defined concentration for securing the highest gain.

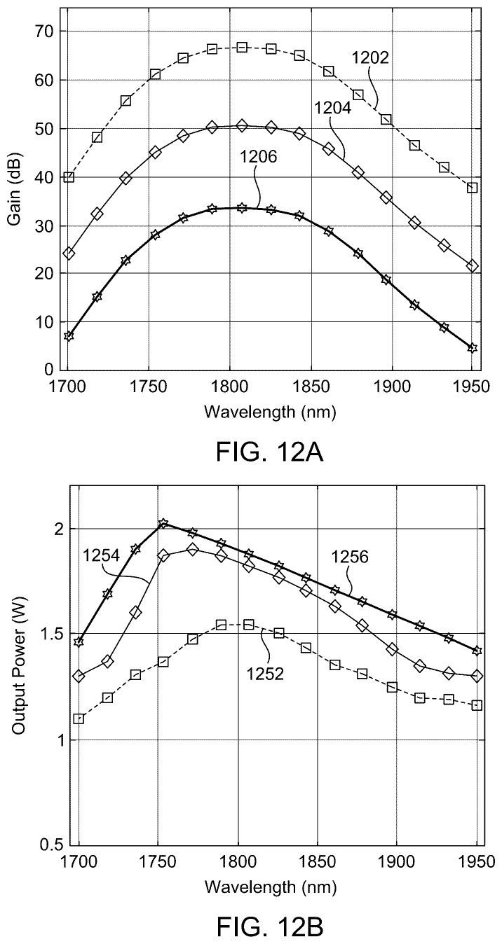

FIG. 12A-FIG. 12B show a relationship between signal wavelength and both gain and output power, varying according to signal power, with the parameters optimized for a pump power of 5 W (e.g., 2.5 W for each pump 328-1 and 328-2 of the dual-stage pumping configuration of FIG. 3C).

FIG. 12A is a graph illustrating signal wavelength versus gain of the dual-hop system 100 as a function of signal power. Curve 1202 shows the gain of the TDFA 325 when the signal power is −35 dBm. Curve 1204 shows the gain of the TDFA 325 when the signal power is −17.5 dBm. Curve 1206 shows the gain of the TDFA 325 when the signal power is 0 dBm. The amplifier's gain reaches its minimum value of 33.6 dB at a signal power of 0 dBm and ascends to a maximum of 66.6 dB at a signal power of −35 dBm, both occurring at a wavelength of 1807.143 nm. A drop in the amplifier's gain for wavelengths extending beyond 1810 nm is observed across all signal powers. This pattern can be attributed to a higher population of Tm³⁺ ions residing in the lower energy manifold compared to the higher energy state.

FIG. 12B is a graph illustrating signal wavelength versus output power of the dual-hop system 100 as a function of signal power. Curve 1252 shows the output power of the TDFA 325 when the signal power is −35 dBm. Curve 1254 shows the output power of the TDFA 325 when the signal power is −17.5 dBm. Curve 1256 shows the output power of the TDFA 325 when the signal power is 0 dBm. The output power of the amplifier was at lowest, 1.54 W, for a signal power of −35 dBm at 1807.143 nm. Conversely, the output power was at peak at 2 W with a signal power of 0 dBm, occurring at a wavelength of 1771.429 nm.

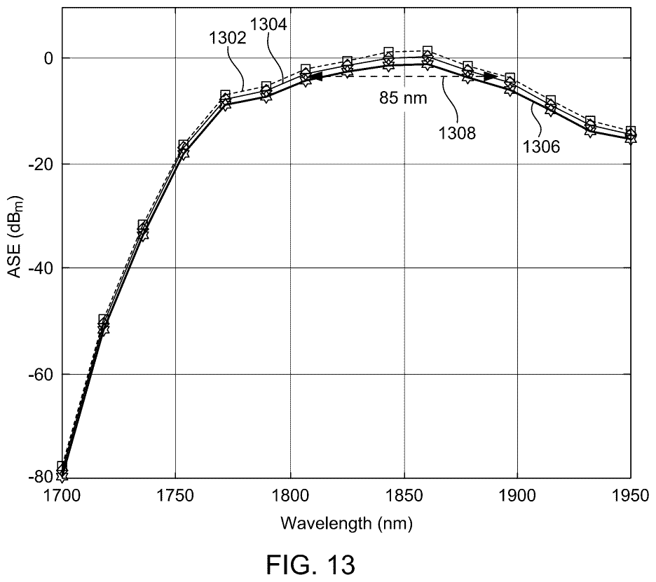

FIG. 13 is a graph illustrating signal wavelength versus amplified spontaneous emission (ASE) of the dual-hop system 100 as a function of pump power with the parameters optimized for a signal power of −35 dBm. Curve 1302 depicts the ASE of the TDFA 325 when the pump power is 2.5 W. Curve 1304 depicts the ASE of the TDFA 325 when the pump power is 2 W. Curve 1302 depicts the ASE of the TDFA 325 when the pump power is 1.5 W. As can be observed from FIG. 13, the peak ASE, measuring at 1.54 dBm, was achieved at a signal wavelength of 1860.714 nm when utilizing a pump power of 5 W (2.5 W for each pump). A declining trend in ASE occurred at higher wavelengths, attributable to the influence of ground state absorption resulting from inadequate population inversion, as detailed in source. Moreover, a 3 dB ASE bandwidth of 85 nm was recorded at the pump power of 5 W (as shown by 1308).

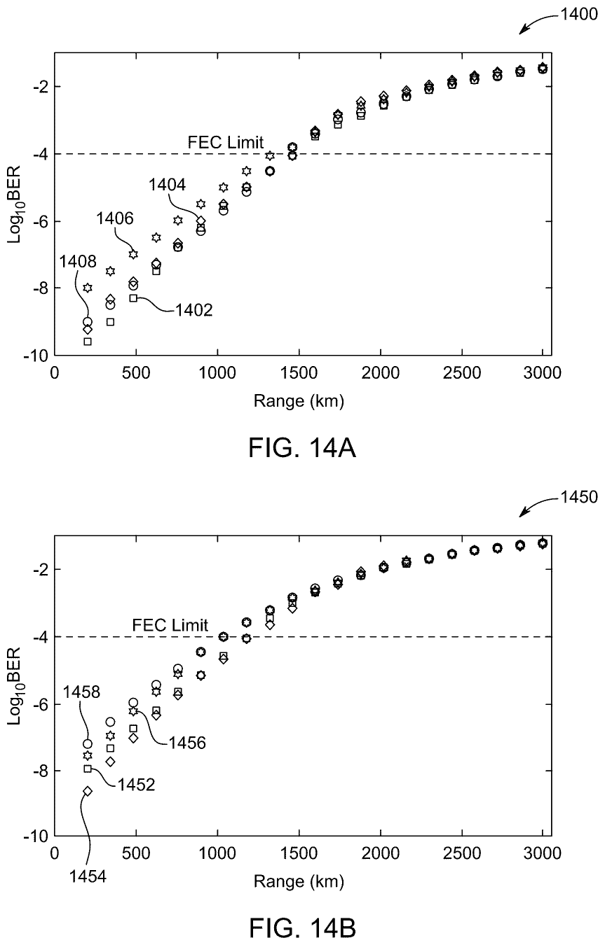

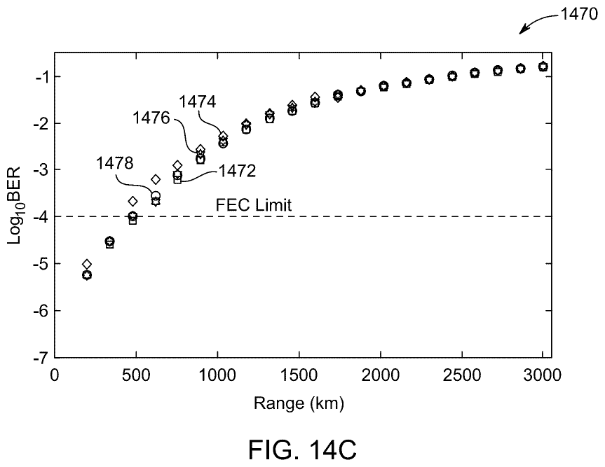

FIG. 14A-FIG. 14B, demonstrate the system-level performance of the TDFA 325, evaluated by varying OWC link ranges in correlation to the bit error rate (BER), under a strong turbulence regime, for four channels. In as aspect, the first OWC link range was consistently maintained at 10 km, while the second OWC link range was adjusted up to 3000 km. This adjustment in the overall OWC link range produces different BER values across multiple channels. It is pivotal to recognize that a Forward Error Correction (FEC) limit of 10⁻⁴ is considered in these assessments.

FIG. 14A is a graph 1400 illustrating range versus bit error rate (BER) for four channels using the dual-hop system 100 obtained at 0.22 dB/m. Curve 1402 represents BER corresponding to channel 1. Curve 1404 represents BER corresponding to channel 2. Curve 1406 represents BER corresponding to channel 3. Curve 1408 represents BER corresponding to channel 4.

FIG. 14B is a graph 1450 illustrating range versus BER for four channels using the dual-hop system 100 obtained at 4 dB/m. Curve 1452 represents BER corresponding to channel 1. Curve 1454 represents BER corresponding to channel 2. Curve 1456 represents BER corresponding to channel 3. Curve 1458 represents BER corresponding to channel 4.

FIG. 14C is a graph 1470 illustrating range versus BER for four channels using the dual-hop system 100 obtained at 5 dB/m. Curve 1472 represents BER corresponding to channel 1. Curve 1474 represents BER corresponding to channel 2. Curve 1476 represents BER corresponding to channel 3. Curve 1478 represents BER corresponding to channel 4.

It is evident that with an atmospheric attenuation of 0.22 dB/km, an optimal error-free average range of approximately 1450 km is attainable for all channels while adhering to the FEC limit. When the atmospheric attenuation increases to 4 dB/km, this optimal error-free range diminishes to around 1100 km for all channels, still within the FEC threshold. A further increment in atmospheric attenuation to 5 dB/km reduces the maximum error-free average range to 500 km across all channels.

It is also noteworthy that a negligible variation in the achieved average range at the FEC limit is observed amongst all four channels at the varying levels of atmospheric attenuation, confirming the consistency and reliability of the TDFA's performance under diverse environmental conditions.

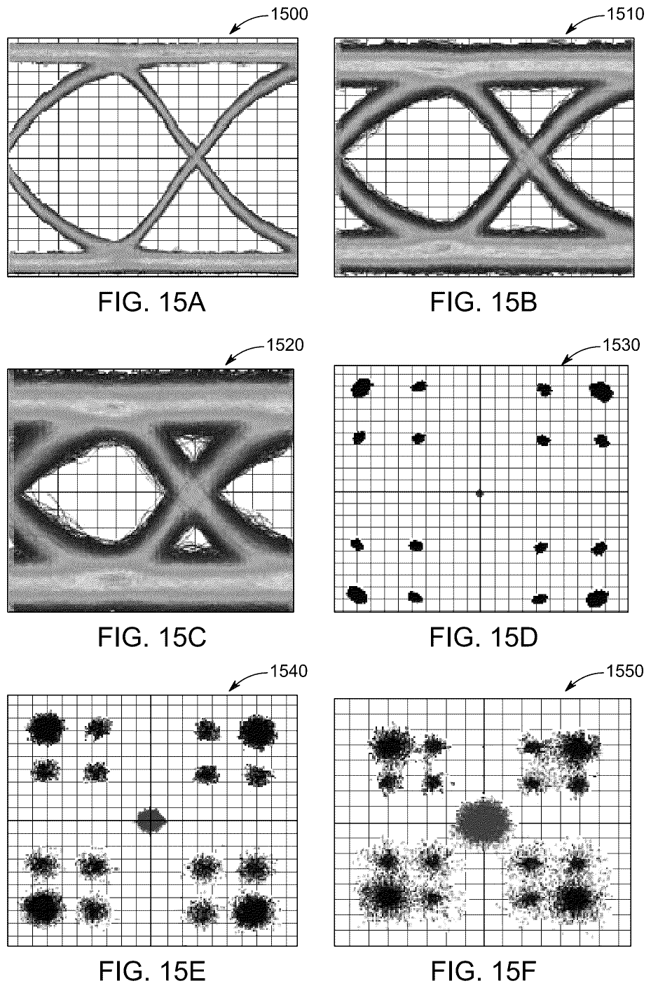

FIG. 15A-FIG. 15F provide an in-depth analysis of the performance of the four channels, specifically focusing on channel-1, by presenting eye diagrams and constellation plots at the FEC limit under strong turbulence and various levels of atmospheric attenuation.

FIG. 15A illustrates an eye diagram 1500 of a first channel (channel-1) obtained at atmospheric attenuation of 0.22 dB/km.

FIG. 15B illustrates an eye diagram 1510 of the first channel (channel-1) obtained at atmospheric attenuation of 4 dB/km.

FIG. 15C illustrates an eye diagram 1520 of the first channel (channel-1) obtained at atmospheric attenuation of 5 dB/km.

FIG. 15D illustrates a constellation plot 1530 of the first channel (channel-1) obtained at atmospheric attenuation of 0.22 dB/km.

FIG. 15E illustrates a constellation plot 1540 of the first channel (channel-1) obtained at atmospheric attenuation of 4 dB/km.

FIG. 15F illustrates a constellation plot 1550 of the first channel (channel-1) obtained at atmospheric attenuation of 5 dB/km.

It is evident from FIG. 15A-FIG. 15C that as the atmospheric attenuation increases, the openness of the eye diagrams contracts, illustrating a decline in signal quality. In a similar manner, FIG. 15D-FIG. 15F display the constellation plots of channel-1 under the same atmospheric attenuations. The plots reveal that as the attenuation increases, there is a discernible broadening of the constellations due to reduced received optical power at the photodetector. Despite this broadening effect, the constellations remain distinct, ensuring that signal interpretation at the receiver remains straightforward and reliable.

The performance of the dual-hop system 100 is compared with the aforementioned existing amplifying systems and is summarized in Table 3. It is observed from the Table 3 that the dual-hop system 100 is efficient in comparison to conventional amplifying systems.

TABLE 3
Summary of performance comparison

| | | | | | | | | No. of |
|---|---|---|---|---|---|---|---|---|
| | | | | | | | | pumps & |
| | | | | | | TDF | | pumping |
| Study | Gain | | NF | | PCE | length | | stage |
| Tench RE | 46 | dB | 7 | dB | 26.5% | 4 m, 2 m | | 1, 2 |
| C. Romano | 60 | dB | 7 | dB | 78.7% | 4.3 m, 2 m | | 2, 2 |
| C. Gaida | — | | — | | 60% | — | | 2, 1 |
| Mukhtar S | 41 | dB | 4.2 | dB | — | 10 | m | 1, 1 |
| Jin X | — | | — | | 87% | 7 | m | 2, 1 |
| Khamis | 35 | dB | — | | — | 0.7 | m | 1, 1 |
| MA | | | | | | | | |
| Li Z | 29 | dB | 6.5 | dB | — | 0.5 m, 0.5 m | | 2, 1 |
| M.A. | 30 | dB | 6.5 | dB | — | 1.25 | m | 2, 1 |
| Khamis | | | | | | | | |
| Y. Jung | 36 | dB | 4.5 | dB | — | 8 | m | 2, 1 |
| Tench RE | 60 | dB | 4 | dB | 54.2% | 4.3 m, 2 m | | 1, 2 |
| Singh R | 27 | dB | 6.5 | dB | — | 10 | m | 3, 1 |

| | | | | | | | |
|---|---|---|---|---|---|---|---|
| Tench RE | 50 | dB | 4 | dB | 82% | 7 m, 5 m | 3, 2 |
| Tench RE | 49.1 | dB | 6.5 | dB | 13.4% | 3 m, 2.5 m | 1, 2 |
| Tench RE | 54 | dB | 10 | dB | 70% | 3 m, 2 m, 5 m | 3, 3 |
| Dual-hop | 66.6 | dB | 4.4 | dB | 95% | 1.5 m, 1.5 m | 2, 2 |

system 100

The first embodiment is illustrated with respect to FIG. 6. The first embodiment describes a method of transmitting data between earth station 102 and satellite 108 over an optical wireless communication (OWC) channel using a dual-hop system 100. The method includes amplifying an input optical signal using a first thulium-doped fiber amplifier (TDFA) 514 to generate an amplified signal. The method includes transmitting, from a base station located on the surface of Earth, the amplified signal to the HAPS 106 over the OWC channel for further transmission to a satellite 108 in a specified earth orbit, wherein the HAPS 106 is installed at a specified altitude from the surface of Earth. The method includes compensating, using a second TDFA 518, for attenuation of the amplified signal by amplifying the amplified signal to generate an output optical signal. The method includes transmitting, from the HAPS 106, the output optical signal to the satellite 108 over the OWC channel, wherein amplifying using the first TDFA 514 and the second TDFA 518 includes configuring the first TDFA 514 or the second TDFA 518 based on a mode of operation of the first TDFA 514 and the second TDFA 518 to provide an output power or a gain that satisfies a specified criterion.

In an aspect, the step of configuring the first TDFA 514 or the second TDFA 518 includes: configuring the mode of operation of the first TDFA 514 as a booster amplifier to amplify a power of the input optical signal by a specified amount and configuring the mode of operation of the second TDFA 518 as an in-line amplifier to provide a specified gain in amplifying the amplified signal.

In an aspect, the specified criterion includes (a) the output power of the first TDFA 514, or (b) the gain provided by the second TDFA 518 being the highest among the output power or gain provided for different wavelengths of the input optical signal.

In an aspect, the step of configuring the first TDFA 514 includes determining, for each length of different lengths of a first TDF of the first TDFA 514 (e.g., a pair of TDFs, such as TDFs 310-1 and 310-2, associated with the first TDFA), the output power of the first TDFA 514 for different wavelengths of the input optical signal, and selecting a length (e.g., 1.5 m for each TDF of the pair of TDFs as illustrated in FIG. 7A) from the different lengths for which the output power satisfies the specified criterion as a specified length of the first TDF 310-1.

In an aspect, the step of configuring the first TDFA 514 includes determining, for each thulium concentration amount of different thulium concentration amounts of a first TDF of the first TDFA 514, the output power of the first TDFA 514 for different wavelengths of the input optical signal, and selecting a thulium concentration amount (e.g., 12.5×10²⁴ m⁻³ as illustrated in FIG. 7B) from the different thulium concentration amounts for which the output power of the first TDFA 514 satisfies the specified criterion as a specified thulium concentration amount of the first TDF.

In an aspect, the step of configuring the first TDFA 514 includes determining a gain of the first TDFA 514 for different wavelengths of the input optical signal, and selecting a wavelength (e.g., 1807.143 nm as illustrated in FIG. 8A) among the different wavelengths for which the gain satisfies the specified criterion as the wavelength of the input optical signal. In an aspect, the step of configuring the first TDFA 514 includes determining a noise factor of the first TDFA 514 for different wavelengths of the input optical signal, and selecting a wavelength (e.g., 1807.143 nm as illustrated in FIG. 8A) among the different wavelengths for which the noise factor is below a specified threshold as the wavelength of the input optical signal.

In an aspect, the step of configuring the first TDFA 514 includes determining, for each wavelength of different wavelengths of light input by each optical pump of the first TDFA 514, output power or the gain in amplifying the input signal, and selecting a wavelength (e.g., 1210 nm as illustrated in FIG. 9A) from the different wavelengths of the light input by the optical pump above which a degree of change in the output power or the gain is below a specified threshold as a specified wavelength of the light input by the optical pumps.

In an aspect, the step of configuring the second TDFA 518 includes determining, for each length of different lengths of a second TDF of the second TDFA 518 (e.g., a pair of TDFs, such as TDFs 310-1 and 310-2, associated with the second TDFA), the gain provided by of the second TDFA 518 for different wavelengths of the input optical signal, and selecting a length (e.g., 6 m for each TDF of the pair of TDFs as illustrated in FIG. 11A) from the different lengths for which the gain satisfies the specified criterion as a specified length of the second TDF.

In an aspect, the step of configuring the second TDFA 518 includes determining, for each thulium concentration amount of different thulium concentration amounts of a second TDF of the second TDFA 518, the gain of the second TDFA 518 for different wavelengths of the input optical signal, and selecting a thulium concentration amount (e.g., 25×10²⁴ m⁻³ as illustrated in FIG. 7B) from the different thulium concentration amounts for which the gain of the second TDFA 518 satisfies the specified criterion as a specified thulium concentration amount of the second TDF.

In an aspect, the step of configuring the second TDFA 518 includes determining, for each power value of different power values of the input optical signal, the gain of the second TDFA 518 for different wavelengths of the input optical signal, and selecting a power value (e.g., −35 dBm as illustrated in FIG. 12A) from the different power values for which the gain satisfies the specified criterion as the power of the input optical signal.

In an aspect, the first TDFA 514 and the second TDFA 518 are configured to operate in booster amplifier mode of operation.

In an aspect, the first TDFA 514 and the second TDFA 518 are configured to operate in in-line amplifier mode of operation.

In an aspect, the step of configuring the first TDFA 514 or the second TDFA 518 includes: configuring at least one of: a length of a first TDF of the first TDFA 514 and a second TDF of the second TDFA 518, a thulium concentration amount of the first TDF and the second TDF, a wavelength of light input by optical pumps of the first TDFA 514 and the second TDFA 518, or a wavelength or power of the input optical signal.

The second embodiment is illustrated with respect to FIG. 1-FIG. 5. The second embodiment describes the dual-hop system 100 for amplifying optical signals. The dual-hop system 100 includes a first thulium-doped fiber amplifier (TDFA) 514, and a second TDFA 518. The first TDFA 514 is installed in a base station located on the surface of Earth. The first TDFA 514 includes a first TDF (e.g., a pair of TDFs, such as TDFs 310-1 and 310-2, associated with the first TDFA) and a first set of optical pumps (e.g., a pair of optical pumps associated with the first TDFA, such as 328-1 and 328-2 of the dual-stage pumping configuration of FIG. 3C). The first TDFA 514 is configured to amplify an input optical signal to generate an amplified signal. The base station 102 is configured to wirelessly transmit the amplified signal to HAPS 106 installed at a specified altitude from the surface of Earth. The second TDFA 518 is installed in the HAPS 106. The second TDFA 518 includes a second TDF (e.g., a pair of TDFs, such as TDFs 310-1 and 310-2, associated with the second TDFA) and a second set of optical pumps (e.g., a pair of optical pumps associated with the second TDFA, such as 328-1 and 328-2 of the dual-stage pumping configuration of FIG. 3C). The second TDFA 518 is configured to compensate for attenuation of the amplified signal by amplifying the amplified signal to generate an output optical signal. The HAPS 106 is configured to further transmit the output optical signal to a satellite 108 wirelessly. The first TDF, the second TDF, the first set of optical pumps and the second set of optical pumps are further configured based on a mode of operation of the first TDFA 514 and the second TDFA 518 to provide a power amplification, or gain in amplifying the input optical signal, that satisfies a specified criterion.

In an aspect, the specified criterion includes (a) output power provided by the first TDFA 514, or (b) the gain provided by the second TDFA 518, being the highest among output power or gain provided for various wavelengths of the input optical signal.

In an aspect, the first TDFA 514 is configured to operate in a booster amplifier mode of operation and the second TDFA 518 is configured to operate in an in-line amplifier of operation.

In an aspect, the length of the first TDF is configured to provide the power amplification by the first TDFA 514 that satisfies the specified criterion, and wherein the length of the second TDF is configured to provide the gain that satisfies the specified criterion.

In an aspect, the first TDF has a first thulium concentration amount that enables the first TDFA 514 to provide the power amplification that satisfies the specified criterion, and wherein the second TDF has a second thulium concentration amount that enables the second TDFA 518 to provide the gain that satisfies the specified criterion.

In an aspect, the first set of optical pumps and the second set of optical pumps are configured to input light of a specified wavelength, wherein the specified wavelength is one of different wavelengths of the input light above which a degree of change in an output power or the gain of the first TDFA 514 or the second TDFA 518 is below a specified threshold.

The above-described hardware description is a non-limiting example of corresponding structure for performing the functionality described herein.

Numerous modifications and variations of the present disclosure are possible in light of the above teachings. It is therefore to be understood that within the scope of the appended claims, the disclosure may be practiced otherwise than as specifically described herein.

1. A method of transmitting data between Earth and satellite over an optical wireless communication (OWC) channel using a dual-hop system, the method comprising:
amplifying an input optical signal using a first thulium-doped fiber amplifier (TDFA) to generate an amplified signal;
transmitting, from a base station located on a surface of Earth, the amplified signal to a high-altitude platform station (HAPS) over the OWC channel for further transmission to a satellite in a specified earth orbit, wherein the HAPS is installed at a specified altitude from the surface of Earth;
compensating, using a second TDFA, for attenuation of the amplified signal by amplifying the amplified signal to generate an output optical signal; and
transmitting, from the HAPS, the output optical signal to the satellite over the OWC channel, wherein amplifying using the first TDFA and the second TDFA includes configuring the first TDFA or the second TDFA based on a mode of operation of the first TDFA and the second TDFA to provide an output power or a gain that satisfies a specified criterion.

2. The method of claim 1, wherein configuring the first TDFA or the second TDFA includes:
configuring the mode of operation of the first TDFA as a booster amplifier to amplify a power of the input optical signal by a specified amount, and
configuring the mode of operation of the second TDFA as an in-line amplifier to provide a specified gain in amplifying the amplified signal.

3. The method of claim 2, wherein the specified criterion includes (a) the output power of the first TDFA, or (b) the gain provided by the second TDFA being the highest among the output power or gain provided for different wavelengths of the input optical signal.

4. The method of claim 2, wherein configuring the first TDFA includes:
determining, for each length of different lengths of a first thulium-doped fiber (TDF) of the first TDFA, the output power of the first TDFA for different wavelengths of the input optical signal, and
selecting a length from the different lengths for which the output power satisfies the specified criterion as a specified length of the first TDF.

5. The method of claim 2, wherein configuring the first TDFA includes:
determining, for each thulium concentration amount of different thulium concentration amounts of a first TDF of the first TDFA, the output power of the first TDFA for different wavelengths of the input optical signal, and
selecting a thulium concentration amount from the different thulium concentration amounts for which the output power of the first TDFA satisfies the specified criterion as a specified thulium concentration amount of the first TDF.

6. The method of claim 2, wherein configuring the first TDFA includes:
determining a gain of the first TDFA for different wavelengths of the input optical signal, and
selecting a wavelength among the different wavelengths for which the gain satisfies the specified criterion as the wavelength of the input optical signal.

7. The method of claim 2, wherein configuring the first TDFA includes:
determining a noise factor of the first TDFA for different wavelengths of the input optical signal, and
selecting a wavelength among the different wavelengths for which the noise factor is below a specified threshold as the wavelength of the input optical signal.

8. The method of claim 2, wherein configuring the first TDFA includes:
determining, for each wavelength of different wavelengths of light input by an optical pump of the first TDFA, output power or the gain in amplifying the input signal, and
selecting a wavelength from the different wavelengths of the light input by the optical pump above which a degree of change in the output power or the gain is below a specified threshold as a specified wavelength of the light input by the optical pump.

9. The method of claim 2, wherein configuring the second TDFA includes:
determining, for each length of different lengths of a second TDF of the second TDFA, the gain provided by the second TDFA for different wavelengths of the input optical signal, and
selecting a length from the different lengths for which the gain satisfies the specified criterion as a specified length of the second TDF.

10. The method of claim 2, wherein configuring the second TDFA includes:
determining, for each thulium concentration amount of different thulium concentration amounts of a second TDF of the second TDFA, the gain of the second TDFA for different wavelengths of the input optical signal, and
selecting a thulium concentration amount from the different thulium concentration amounts for which the gain of the second TDFA satisfies the specified criterion as a specified thulium concentration amount of the second TDF.

11. The method of claim 2, wherein configuring the second TDFA includes:
determining, for each power value of different power values of the input optical signal, the gain of the second TDFA for different wavelengths of the input optical signal, and
selecting a power value from the different power values for which the gain satisfies the specified criterion as the power of the input optical signal.

12. The method of claim 1, wherein the first TDFA and the second TDFA are configured to operate in booster amplifier mode of operation.

13. The method of claim 1, wherein the first TDFA and the second TDFA are configured to operate in in-line amplifier mode of operation.

14. The method of claim 1, wherein configuring the first TDFA or the second TDFA includes:
configuring at least one of:
(a) a length of a first TDF of the first TDFA and a second TDF of the second TDFA,
(b) a thulium concentration amount of the first TDF and the second TDF,
(c) a wavelength of light input by optical pumps of the first TDFA and the second TDFA, or
(d) a wavelength or power of the input optical signal.

15. A dual-hop system for optical wireless communication between a base station on Earth and satellite, the system comprising:
a first thulium-doped fiber amplifier (TDFA) installed in a base station located on the surface of Earth and comprising a first thulium-doped fiber (TDF) and a first set of optical pumps, wherein the first TDFA is:
configured to amplify an input optical signal to generate an amplified signal, wherein the base station is configured to wirelessly transmit the amplified signal to a high-altitude platform station (HAPS) installed at a specified altitude from the surface of Earth; and
a second TDFA installed in the HAPS and comprising a second TDF and a second set of optical pumps, wherein the second TDFA is:
configured to compensate for attenuation of the amplified signal by amplifying the amplified signal to generate an output optical signal, wherein the HAPS is configured to further transmit the output optical signal to a satellite wirelessly,
wherein the first TDF, the second TDF, the first set of optical pumps and the second set of optical pumps are further configured based on a mode of operation of the first TDFA and the second TDFA to provide a power amplification, or gain in amplifying the input optical signal, that satisfies a specified criterion.

16. The system of claim 15, wherein the specified criterion includes (a) output power provided by the first TDFA, or (b) the gain provided by the second TDFA, being the highest among output power or gain provided for various wavelengths of the input optical signal.

17. The system of claim 15, wherein the first TDFA is configured to operate in a booster amplifier mode of operation and the second TDFA is configured to operate in an in-line amplifier mode of operation.

18. The system of claim 17, wherein the length of the first TDF is configured to provide the power amplification by the first TDFA that satisfies the specified criterion, and wherein the length of the second TDF is configured to provide the gain that satisfies the specified criterion.

19. The system of claim 17, wherein the first TDF has a first thulium concentration amount that enables the first TDFA to provide the power amplification that satisfies the specified criterion, and wherein the second TDF has a second thulium concentration amount that enables the second TDFA to provide the gain that satisfies the specified criterion.

20. The system of claim 17, wherein the first set of optical pumps and the second set of optical pumps are configured to input light of a specified wavelength, wherein the specified wavelength is one of different wavelengths of the input light above which a degree of change in an output power or the gain of the first TDFA or the second TDFA is below a specified threshold.
